(19) United States
(12) Patent Application Publication
(10) Pub. No.: US 2025/0232897 A1
(43) Pub. Date: Jul. 17, 2025

(54) TAPE WINDING METHOD AND WIRE HARNESS

(71) Applicant: Yazaki Corporation, Tokyo (JP)

(72) Inventors: Hiroyasu KOBAYASHI, Makinohara-shi (JP); Takahito FUJIKAWA, Susono-shi (JP); Jun YAGI, Makinohara-shi (JP); Kenji KATSUMATA, Susono-shi (JP)

(73) Assignee: Yazaki Corporation, Tokyo (JP)

(21) Appl. No.: 19/096,908

(22) Filed: Apr. 1, 2025

Related U.S. Application Data
(63) Continuation of application No. PCT/JP2024/007193, filed on Feb. 28, 2024.

(30) Foreign Application Priority Data
Mar. 30, 2023 (JP) 2023-055113

(51) Int. Cl. H01B 13/012; H01B 7/00; H01B 7/18

(52) U.S. Cl. CPC H01B 13/01281; H01B 7/0045; H01B 7/1855

(57) ABSTRACT

A tape winding method includes an oblique winding step, in which a tape set is arranged obliquely so that each tape is wound obliquely at a predetermined angle, the tape spacing is adjusted so that a winding tape pitch is smaller than or equal to a tape width, and in this state, oblique winding is performed while moving the tape set by a movement amount, wherein the movement amount per turn of the oblique winding is defined by multiplying a sum of the winding tape pitch and a winding tape width of one tape by a number of tapes.

### BACKGROUND OF THE INVENTION

### Technical Field

The present invention relates to a tape winding method for winding a tape around an object intended for winding the tape therearound, and to a wire harness with tape winding according to such a tape winding method, wherein the object is one electric wire or a bundle of electric wires.

### Background Art

Conventionally, a tape winding method is known in which a tape is wound around an object intended for winding the tape therearound, the object being one electric wire or a bundle of electric wires, wherein the tape winding method is carried out e.g. for bundling and/or protecting the electric wires (see e.g. Patent Document 1). A tape winding method according to Patent Document 1 provides winding a tape around an object by means of lap winding, in which the tape is wound with overlap of a half width of the tape.

In addition to the lap winding, another tape winding method is known which uses coarse winding, wherein in the coarse winding, tapes are wound in a spiral shape with one or more gaps between the tapes. In some cases, the tapes for tape winding with coarse winding are wound with one or more gaps between the tapes, a winding tape pitch(es), at one or more locations along a length direction which require such a gap, wherein the winding tape pitch is designated e.g. according to a product standard.

### CITATION LIST

### Patent Literature

Patent Document 1: JP 2001-067955 A

### SUMMARY OF THE INVENTION

The tape winding method with coarse winding as described above has the problem that a movement amount of the tapes per turn of winding may be limited due to a desired winding tape pitch which is designated e.g. according to a product standard, which may make it difficult to increase an efficiency of the tape winding operation.

Therefore, the invention is focused on the above-mentioned problem, and an objective of the present invention is to provide a tape winding method which may enable an operation efficiency of a tape winding operation to be increased while achieving a desired winding tape pitch. Another objective of the present invention is to provide a wire harness with tape winding according to such a tape winding method.

In order to achieve this object, a tape winding method includes:
a winding start step of winding a tape around a winding start portion of an object intended for winding the tape therearound, the object being one electric wire or a bundle of electric wires, wherein the tape is wound around the object in a predetermined winding manner;
subsequently to the winding start step, an oblique winding step of performing oblique winding of a plurality of tapes around the object, the plurality of tapes forming a tape set,
   wherein the plurality of tapes of the tape set has a same tape width or different tape widths from each other and is arranged in a winding axis direction,
   wherein during the oblique winding, the plurality of tapes is arranged obliquely so that each of the plurality of tapes of the tape set is wound around the object obliquely at a predetermined angle with a length direction of the object,
   wherein when the plurality of tapes of the tape set has a same tape width, a tape-to-tape distance between the plurality of tapes of the tape set is adjusted so that the plurality of tapes is wound around the object obliquely at a winding tape pitch which is greater than or equal to zero and smaller than or equal to three times as large as the tape width, the winding tape pitch being defined along the length direction,
   wherein when the plurality of tapes of the tape set has different tape widths, the tape-to-tape distance between the plurality of tapes of the tape set is adjusted so that the plurality of tapes is wound around the object obliquely at a winding tape pitch which is greater than or equal to zero and smaller than or equal to three times as large as a maximum tape width of the plurality of tapes,
   wherein the oblique winding is performed while moving the tape set by a movement amount in a direction of movement along the length direction,
   wherein the movement amount per turn of the oblique winding is defined by multiplying a sum of the winding tape pitch and an intersection width of one of the plurality of tapes with the length direction by a number of tapes of the tape set; and
subsequently to the oblique winding step, a winding end step of winding a tape around a winding end portion of the object in a same winding manner as the winding start step.

Furthermore, in order to achieve the above-mentioned objective, a wire harness includes:
an object intended for winding a tape therearound, the object including one electric wire or a bundle of electric wires;
a winding start section in which the tape is wound around a winding start portion of the object in a predetermined winding manner;
an oblique winding section adjacent to the winding start section, in which oblique winding of a plurality of tapes is provided around the object along a length direction of the object,
   wherein the plurality of tapes has a same tape width or different tape widths from each other and is arranged at a predetermined angle with the length direction,
   wherein when the plurality of tapes of the tape set has a same tape width, the plurality of tapes is wound around the object obliquely at a winding tape pitch which is greater than or equal to zero and smaller than or equal to three times as large as the tape width,
   wherein when the plurality of tapes of the tape set has different tape widths, the plurality of tapes is wound around the object obliquely at a winding tape pitch which is greater than or equal to zero and smaller than or equal to three times as large as a maximum tape width of the plurality of tapes,
   wherein the oblique winding is made with a winding length along the length direction,
   wherein the winding length per turn of the oblique winding is defined by multiplying a sum of the winding tape pitch and an intersection width of one of the plurality of tapes with the length direction by a number of tapes of the tape set; and
a winding end section adjacent to the oblique winding section, in which a tape is wound around a winding end portion of the object in a same winding manner as the winding start section, wherein tape winding is provided according to the above-described tape winding method.

The tape winding method and wire harness 1 enable the operation efficiency of the tape winding operation to be increased while achieving a desired winding tape pitch.

### BRIEF DESCRIPTION OF THE DRAWINGS

FIG. 1 schematically shows a wire harness, illustrating a tape set used for a tape winding operation together;

FIG. 2 schematically shows processes of a tape winding method for forming the wire harness as shown in FIG. 1;

FIG. 3 shows a winding tape pitch, a tape spacing in a tape set, and a winding tape width between tapes with which are wound around an object intended for winding a tape therearound in an oblique winding step as shown in FIG. 2 for explanation of their relationship; and

FIG. 4 shows a view for explanation of a movement amount of the tape set per turn of the oblique winding in the oblique winding step as shown in FIG. 2.

### DETAILED DESCRIPTION OF THE PREFERRED EMBODIMENTS

Hereinafter, embodiments of a tape winding method and a wire harness will be described.

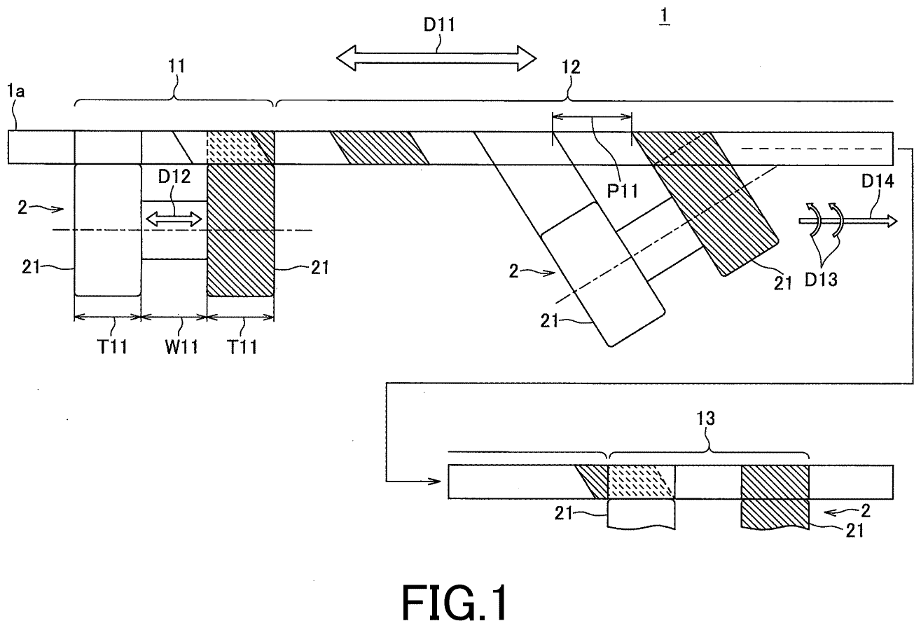

FIG. 1 schematically shows a wire harness, illustrating a tape set used for a tape winding operation together.

As an example, the wire harness 1 according to the present embodiment is installed and extends e.g. in a vehicle. Furthermore, the wire harness 1 is configured by coarse winding, i.e., by winding tapes around an outer circumference of an electric wire in a spiral shape with one or more gaps between the tapes e.g. for the purpose of bundling and/or protecting the electric wire(s). The wire harness 1 includes an object intended for winding a tape therearound 1a, a winding start section 11, an oblique winding section 12, and a winding end section 13.

The object 1a is an electric wire component including one electric wire or a bundle of electric wires. In the winding start section 11, a tape is wound around a winding start portion of the object 1a in a winding manner which is described below. The oblique winding section 12 is a section of the wire harness 1 which is adjacent to the winding start section 11. In the oblique winding section 12, oblique winding is applied continuously in a length direction D11 of the object 1a as described below. In the oblique winding section 12, a plurality of tapes 21 (two tapes 21 in the present embodiment) having a same tape width T11 is wound in a spiral shape in the length direction D11 of the object 1a with one or more gaps between the tapes. A winding tape pitch P11 which is the gap between the wound tapes is configured to be smaller than or equal to a tape width T11 (equal to a tape width T11 in the present embodiment). The winding end section 13 a section of the wire harness 1 which is adjacent to the oblique winding section 12, wherein in the winding end section 13, a tape is wound around a winding end portion of the object 1a in a same winding manner as the winding start section 11.

For all of the winding start section 11, oblique winding section 12, and winding end section 13, tape winding is performed by winding a tape set 2 including two tapes 21, wherein the two tapes 21 have a same tape width T11 as each other and are arranged in a winding axis direction D12 with a tape spacing W11. The tape spacing W11 which is a tape-to-tape distance between the two tapes 21 of the tape set 2 is adjusted so that the winding tape pitch P11 is configured as follows in the oblique winding section 12: the tape spacing W11 is adjusted so that when the two tapes 21 have a same tape width T11, the winding tape pitch P11 is greater than or equal to zero and smaller than or equal to three times as large as the tape width T11. On the other hand, the tape spacing W11 is adjusted so that when the two tapes 21 have different tape widths, the winding tape pitch P11 is greater than or equal to zero and smaller than or equal to three times as large as a maximum tape width of the two tapes 21. Since the two tapes 21 according to the present invention have a same tape width T11, the tape spacing W11 is adjusted to be shorter than the tape width T11 so that the winding tape pitch P11 is greater than or equal to zero and smaller than or equal to three times as large as the tape width T11, more specifically equal to the tape width T11. In the winding start section 11 and the winding end section 13, tape winding with the tape set 2 is performed with the tape set 2 being arranged on the object 1a, wherein the tape set 2 is arranged so that the winding axis direction D12 extends along the length direction D11 and the tape winding is performed without moving the tape set 2. In the oblique winding section 12, the tape set 2 is so oblique that each of the tapes 21 forms a predetermined angle with the length direction D11 of the object 1a. During the oblique winding, the tape set 2 is moved in the direction of movement D14 along the length direction D11 of the object 1a while remaining oblique and being rotated around the object 1a in a direction of rotation D13.

Hereinafter, a tape winding method will be described which is used for forming the wire harness 1.

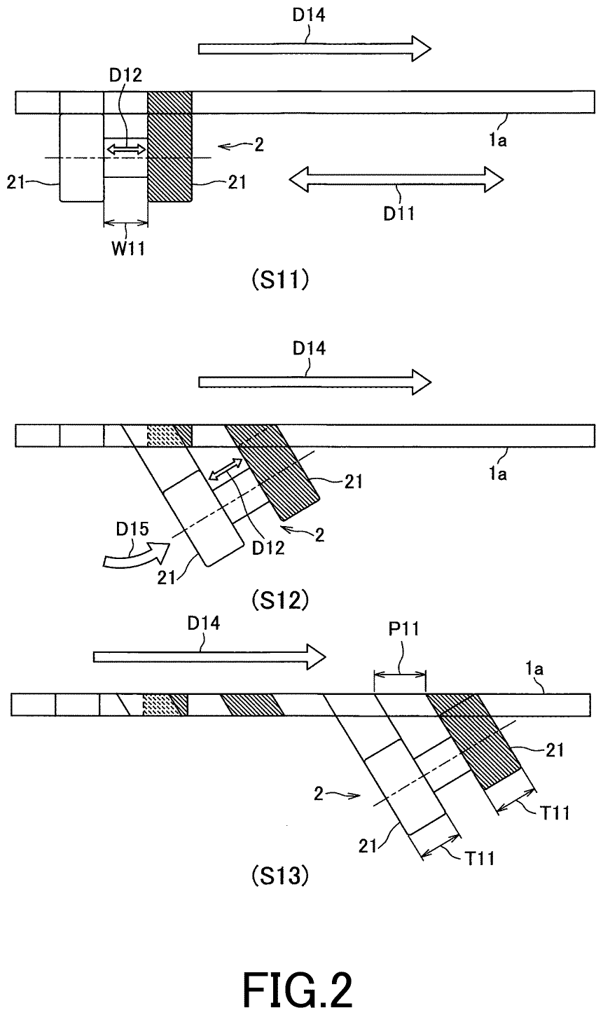

FIG. 2 schematically shows processes of a tape winding method for forming the wire harness as shown in FIG. 1.

In step S11 of the tape winding method as shown in FIG. 2, a winding start step is performed in which tapes are wound around the winding start portion of the object 1a in a winding manner as described below: In the winding start step as step S11, two or more turns of non-movement tape winding are performed in which the tape set 2 is wound around the object 1a without moving the tape set 2 in the direction of movement D14. As described above, the non-movement tape winding is performed with the tape set 2 being arranged on the object 1a, wherein the tape set 2 is arranged so that the winding axis direction D12 extends along the length direction D11. The non-movement tape winding during the winding start step results in double winding of the two tapes 21 with the tape spacing W11 therebetween. The winding start step as step S11 results in the winding start section 11 as shown in FIG. 1.

In the following steps S12 and S13, the following oblique winding step is performed. In the oblique winding step, the tape set 2 with the winding axis direction D12 extending along the length direction D11 according to the winding start step as step S11 is first arranged obliquely in an oblique direction D15 toward a forward side along the direction of movement D14 in step S12. Such oblique arrangement according to this step S12 is accomplished by gradually moving the tape set 2 in the oblique direction D15 while winding the two tapes 21 around the object 1a. In the subsequent step S13, oblique winding is performed with the winding tape pitch P11 being equal to the tape width T11, in which the two tapes 21 of the tape set 2 are wound obliquely.

Here, in the oblique winding step in steps S12 and S13, the winding tape pitch P11, the tape spacing W11 of the tape set 2, and the winding tape width of each tape 21 wound around the object 1a have the following relationship with the tape width T11.

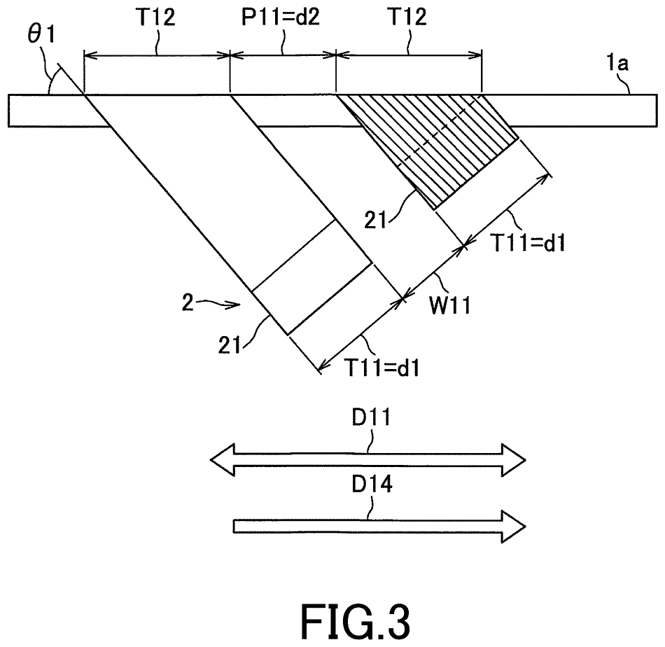

FIG. 3 shows a winding tape pitch, a tape spacing in a tape set, and a winding tape width between tapes with which are wound around an object intended for winding a tape therearound in an oblique winding step as shown in FIG. 2 for explanation of their relationship.

Now, the winding tape pitch P11 of the object along its length direction D11 1a is equal to the tape width T11 of each tape 21 of the tape set 2. Here, a first reference distance d1 and a second reference distance d2 are provided in the form of a same tape width T11 of the two tapes 21 as each other and in the form of winding tape pitch P11. However, it is to be noted that the winding tape pitch P11 is equal to the tape width T11, and therefore, the first reference distance d1 is equal to the second reference distance d2. First, the tape spacing W11 of the tape set 2 may be expressed by the following Formula 1 using the second reference distance d2 and an oblique angle θ1 of each tape 21 relative to the length direction D11 of the object 1a:

$$W 11 = d 2 \times cos ( 90 ° - θ 1 ) \qquad [ Formula 1 ]$$

The tape spacing W11 expressed by Formula 1 is shorter than the winding tape pitch P11 (i.e., the second reference distance d2). According to the present embodiment, since the winding tape pitch P11 is equal to the tape width T11 and the first reference distance d1 is equal to the second reference distance d2, the tape spacing W11 is shorter than the tape width T11 (i.e., the first reference distance d1). With adjustment of the tape spacing W11 of the tape set 2 to have such an amount, the oblique winding step with the oblique angle θ1 results in the obliquely wound tape 21 so that the winding tape pitch P11 is equal to the second reference distance d2 (=first reference distance d1). Then, the winding tape width T12 of each obliquely wound tape 21 may be expressed by the following formula 2:

$$T 12 = \frac{d 1}{cos ( 90 ° - θ 1 )} \qquad [ Formula 2 ]$$

The winding tape width T12 expressed by formula 2 is longer than the tape width T1l (i.e., the first reference distance d1 is equal to the second reference distance d2).

In the oblique winding step in steps S12 and S13 as shown in in FIG. 2, each tape 21 is wound with the winding tape width T12 according to Formula 2 while providing the winding tape pitch P11 equal to the second reference distance d2 (=first reference distance d1) therebetween. In the oblique winding step according to the present embodiment, the oblique winding is wound with the second reference distance d2 in the form of the winding tape pitch P11, wherein the second reference distance d2 remains constant during the oblique winding. During this oblique winding, the tape set 2 is moved by a movement amount of per turn of the oblique winding in the direction of movement D14 along the length direction D11, wherein the movement amount is configured as follows.

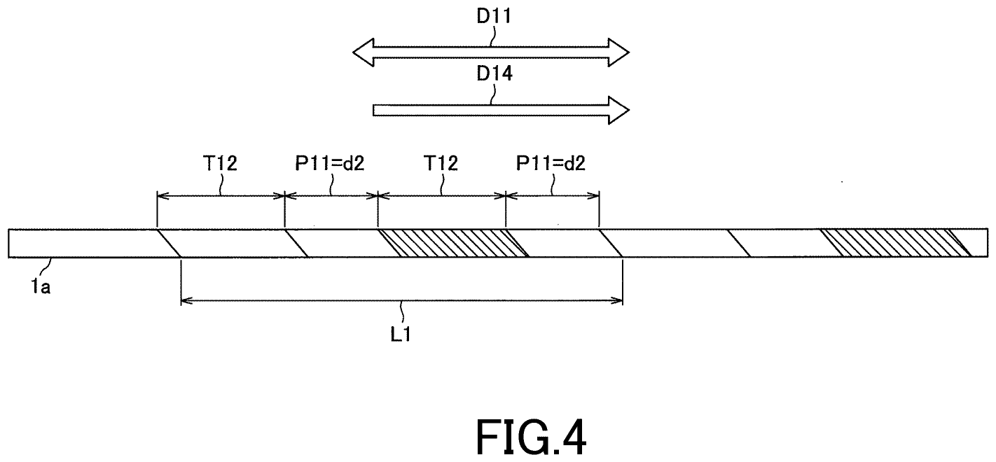

FIG. 4 shows a view for explanation of the movement amount of the tape set per turn of the oblique winding in the oblique winding step as shown in FIG. 2.

As shown in this FIG. 4, the movement amount L1 of the tape set 2 per turn of the oblique winding in the direction of movement D14 along the length direction D11 of the object 1a is a sum of the winding tape width T12 of each of the two tapes 21 and the two winding tape pitches P11 (i.e., the second reference distance d2=first reference distance d1). This movement amount L1 is expressed by the following Formula 3:

$$\begin{matrix}L 1 = ( T 12 + d 2 ) \times 2 \\ = \{ \frac{d 1}{cos ( 90 ° - θ 1 )} + d 2 \} \times 2\end{matrix} \qquad [ Formula 3 ]$$

As expressed by Formula 3, the movement amount L1 of the tape set 2 is defined by multiplying a sum of the winding tape pitch P11, and an intersection width of one of the tapes 21 with the length direction D11, i.e., the winding tape width T12, by a number of tapes of the tape set (two (tapes) in the present embodiment), wherein the winding tape pitch P11 is equal to the second reference distance d2 and constant. In the oblique winding step in steps S12 and S13 in FIG. 2, oblique winding is performed while moving the tape set 2 by this movement amount L1. This movement amount L1 will define the winding length along the length direction D11 per turn of the oblique winding for each tape 21 in the wire harness 1 shown in FIG. 1.

In the oblique winding step, when the oblique winding has proceeded to the winding end portion of the object 1a, oblique arrangement of the tape set 2 is eliminated, and the tape set 2 is then arranged in such a way that the winding axis direction D12 extends along the length direction D11. Similarly to the oblique arrangement of the tape set 2 after the winding start step, the elimination of this oblique arrangement is accomplished by gradually moving the tape set 2 in an elimination direction opposite to the oblique direction D15, while winding the two tapes 21 around the object 1a. With this elimination of oblique arrangement, the oblique winding step in steps S12 and S13 is ended, and the oblique winding section 12 shown in FIG. 1 is formed.

After this elimination of inclination, a winding end step is further performed on the winding end portion in the same winding manner as the winding start step. That is, two turns of non-movement tape winding are performed without moving the tape set 2 in the direction of movement D2 by the tape set 2 with the winding axis direction D12 extending along the length direction D11. This winding end step results in the winding end section 13 shown in FIG. 1, whereby the tape winding method for winding one or more tapes around the wire harness 1 is ended.

According to the tape winding method of the embodiment described above, in portions requiring coarse winding by oblique winding, oblique winding is performed so that the winding tape pitch P11 has the following pitch: when the two tapes 21 of the tape set 2 has a same tape width T11, the winding tape pitch P11 is greater than or equal to zero and smaller than or equal to three times as large as the tape width T11. When the two tapes 21 of the tape set 2 has different tape widths T11, the winding tape pitch is greater than or equal to zero and smaller than or equal to three times as large as the maximum tape width. According to the present embodiment, the tapes 21 have a same tape width T11, and therefore, oblique winding is provided so that the winding tape pitch P11 is greater than or equal to zero and smaller than or equal to three times as large as the tape width T11 (according to the present embodiment, the first reference distance d1=the second reference distance d2 which is equal to the tape width T11). This winding tape pitch P11 is set by adjusting the tape spacing W11 of the tape set 2. In addition, the oblique winding is performed while moving the tape set 2 by the movement amount L1, wherein the movement amount L1 per turn of the oblique winding is defined by multiplying a sum of the winding tape pitch P11 and the winding tape width T12 by a number of tapes (two). With this movement which is allowed by the present disclosure, efficiency for the tape winding operation may be increased as compared to e.g. tape winding with a movement amount per turn of winding being limited to at most twice as large as the tape width. In this manner, the above-described tape winding method enables operation efficiency of the tape winding operation to be increased while achieving a desired winding tape pitch.

Furthermore, a large part of the operation of the tape winding method according to the present embodiment which exists between the winding start step and the winding end step is defined by the oblique winding step including obliquely winding the tapes 21 at the oblique angle θ1 with the length direction D11 of the object 1a. Such an oblique angle θ1 during the tape winding enables wrinkles in the wound tapes 21 to be suppressed.

For example, in the case of oblique winding with one 19 mm wide tape at an oblique angle of 50°, the movement amount of the tape per turn of winding is up to 38 mm.

In contrary, the tape winding method according to the present embodiment results in the movement amount L1 of 87.6 mm per turn of oblique winding with two 19 mm wide tapes 21 at the oblique angle of 50°, which enables the operation efficiency to be increased to about 300%. Furthermore, in the case of two tapes 21 with a width of 25 mm, the movement amount L1 will be 150 mm, which enables the operation efficiency to be increased to 450%.

Here, during the winding start step and during the winding end step according to the present embodiment, two or more turns of non-movement tape winding of the tape set 2 are performed with the winding axis direction D12 extending along the length direction D11. Furthermore, during the oblique winding step, the oblique winding is performed while the tape set 2 is arranged obliquely after the winding start step, and at the winding end portion, oblique arrangement of the tape set 2 is eliminated and then arranged in such a way that the winding axis direction D12 extends along the length direction D11. According to this configuration, at the start and end of tape winding, two turns of non-movement tape winding are performed with the winding axis direction D12 of the tape set 2 extending along the length direction D11 and with each of the tapes 21 extending substantially orthogonally to the object 1a. Such non-movement tape winding enables the winding state at the start and the end of winding to be stabilized.

In addition, during the oblique winding step according to the present embodiment, oblique arrangement of the tape set 2 and elimination of the oblique arrangement is accomplished by gradually moving the tape set 2 while winding the tapes 21. This configuration enables the oblique arrangement of the tape set 2 and elimination of the oblique arrangement to be accomplished by bringing each tape 21 into tight contact with the object 1a and by thus maintaining a good winding state of the tapes 21.

Moreover, during the oblique winding step according to the present embodiment, the oblique winding is performed at the winding tape pitch P11 which is constant. This configuration results in a constant movement amount L1 of the tape set 2 similarly, which may obtain stable tape winding.

According to the present embodiment, the wire harness 1 is formed by tape winding around the object 1a with the above-described tape winding method. This means that the wire harness 1 enables the operation efficiency of the tape winding operation to be increased while achieving a desired winding tape pitch P11 because the above-described tape winding method is applied to the wire harness 1.

It is to be noted that the above-described embodiment merely shows forms representative of the tape winding method and the wire harness. The tape winding method and wire harness are not limited to the embodiment, but may be modified in various manners.

As an example of the wire harness, the above-described embodiment shows the wire harness 1 which is installed and extends e.g. in a vehicle. However, the wire harness is not limited thereto, but may be provided to any specific application.

As an example of a tape set used for the tape winding method, the above-described embodiment shows the tape set 2 formed by two tapes 21 arranged in the winding axis direction D12. However, the tape set is not limited thereto, but may include any number of tapes which is more than one.

As examples of the tape set for use in the tape winding method and of the oblique winding step using the tape set, the above-described embodiment further shows the following tape set 2 and oblique winding step: the tape set 2 includes a plurality of tapes 21 (two tapes 21 in the present embodiment) having a same tape width. In the shown oblique winding step, the winding tape pitch P11 is greater than or equal to zero and smaller than or equal to three times as large as the tape width T11 (equal to the tape width T11 in the present embodiment). However, the tape set and oblique winding step are not limited thereto. The tape set may include tapes with different tape widths. In this case, the winding tape pitch during the oblique winding step may be greater than or equal to zero and smaller than or equal to three times as large as a maximum tape width of the plurality of tapes.

As an example of the oblique winding step, the above-described embodiment further shows the oblique winding step using the oblique angle θ1 of 50°. However, any angle value may be selected for the obliqueness of the tape in the oblique winding step.

As example of the winding start step and winding end step, the above-described embodiment further shows the step S12 in which two turns of non-movement tape winding of the tape set 2 are performed with the winding axis direction D12 extending along the length direction D11. However, the winding start step and winding end step are not limited thereto, but any specific winding manner may be applied in these steps. Nevertheless, step S12 with two turns of non-movement tape winding enables the winding state at the start and the end of winding to be stabilized, as described above. It is to be noted that any number of turns of non-movement tape winding may be selected which is greater than or equal to two.

As an example of the oblique winding step, the present embodiment further shows the oblique winding step including step S12 in which oblique arrangement of the tape set and elimination of the oblique arrangement is accomplished by gradually moving the tape set 2 while winding the tapes 21. However, the oblique winding step is not limited thereto, but for example, the oblique arrangement of the tape set and/or the elimination of the oblique arrangement may be accomplished at once without simultaneously winding the tapes. Nevertheless, gradually moving the tape set 2 while winding the tapes 21 enables the oblique arrangement of the tape set 2 and elimination of the oblique arrangement to be accomplished by bringing each tape 21 into tight contact with the object 1a and by thus maintaining a good winding state of the tapes 21, as described above.

As an example of the tape winding method, the above-described embodiment further shows the tape winding method using the tape set 2, wherein the tape set 2 has the winding tape pitch P11 adjusted to be equal to the tape width T11 and the tape spacing W11 adjusted to be shorter than the tape width T11. However, the tape winding method is not limited thereto, but any pitch may be selected for the winding tape pitch which is smaller than or equal to the tape width, wherein the tape spacing of the tape set may be adjustable corresponding to the winding tape pitch which has been thus selected. Nevertheless, a maximum movement amount of the tape set 2 may be obtained by adjusting the tape spacing W11 and by thus obtaining the winding tape pitch P11 which is equal to the tape width T11, whereby the operation efficiency may be further improved.

As an example of the oblique winding step, the present embodiment further shows the oblique winding step in which the oblique winding is performed at the constant winding tape pitch P11. However, the oblique winding step is not limited thereto, but may include varying the winding tape pitch during oblique winding. For example, in the case of the plurality of tapes having a same tape width, the oblique winding may be performed so that the winding tape pitch may be zero in one winding portion, equal to the tape width in another portion, and twice as large as the tape width in still another portion. Similarly, in the case of the plurality of tapes having different tape widths, the oblique winding may be performed so that the winding tape pitch may be zero in one winding portion, equal to the maximum tape width in another portion, and twice as large as the maximum tape width in still another portion.

### REFERENCE SIGNS LIST

1 Wire harness
1a Object intended for winding a tape therearound
2 Tape set
11 Winding start section
12 Oblique winding section
13 Winding end section
21 Tapes
D11 Length direction
D12 Winding axis direction
D13 Direction of rotation
D14 Direction of movement
D1 Oblique direction
d1 First reference distance
d2 Second reference distance
L1 Direction of movement
P11 Winding tape pitch
T11 Tape width
T12 Winding tape width
W11 Tape spacing
θ1 Oblique angle

What is claimed is:

1. A tape winding method, comprising:
a winding start step of winding a tape around a winding start portion of an object intended for winding the tape therearound, the object being one electric wire or a bundle of electric wires, wherein the tape is wound around the object in a predetermined winding manner;
subsequently to the winding start step, an oblique winding step of performing oblique winding of a plurality of tapes around the object, the plurality of tapes forming a tape set, wherein the plurality of tapes of the tape set has a same tape width or different tape widths to each other and is arranged in a winding axis direction,
wherein during the oblique winding, the plurality of tapes is arranged obliquely so that each of the plurality of tapes of the tape set is wound around the object obliquely at a predetermined angle with a length direction of the object,
wherein when the plurality of tapes of the tape set has a same tape width, a tape-to-tape distance between the plurality of tapes of the tape set is adjusted so that the plurality of tapes is wound around the object obliquely at a winding tape pitch which is greater than or equal to zero and smaller than or equal to three times as large as the tape width, the winding tape pitch being defined along the length direction,
wherein when the plurality of tapes of the tape set has a different tape widths, the tape-to-tape distance between the plurality of tapes of the tape set is adjusted so that the plurality of tapes is wound around the object obliquely at a winding tape pitch which is greater than or equal to zero and smaller than or equal to three times as large as a maximum tape width of the plurality of tapes,
wherein the oblique winding is performed while moving the tape set by a movement amount in a direction of movement along the length direction,
wherein the movement amount per turn of the oblique winding is defined by multiplying a sum of the winding tape pitch and an intersection width of one of the plurality of tapes with the length direction by a number of tapes of the tape set; and
subsequently to the oblique winding step, a winding end step of winding a tape around a winding end portion of the object in a same winding manner as the winding start step.

2. The tape winding method according to claim 1,
wherein during the winding start step and during the winding end step, the tape set is arranged on the object in such a way that the winding axis direction extends along the length direction, and two or more turns of non-movement tape winding are performed,
wherein during the non-movement tape winding, the tape set is wound around the object without moving the tape set in the direction of movement,
wherein during the oblique winding step,
the oblique winding is performed while the tape set is arranged obliquely after the winding start step, and
when the oblique winding has proceeded to the winding end portion, oblique arrangement of the tape set is eliminated, and the tape set is then arranged in such a way that the winding axis direction extends along the length direction.

3. The tape winding method according to claim 2,
wherein during the oblique winding step, oblique arrangement and elimination of the oblique arrangement of the tape set are accomplished by gradually moving the tape set in an oblique direction and in an elimination direction, respectively, while winding the plurality of tapes around the object.

4. The tape winding method according to claim 1,
wherein during the oblique winding step,
the oblique winding is performed at the winding tape pitch which is constant; or
the oblique winding is performed at the winding tape pitch which varies.

5. A wire harness comprising:
an object intended for winding a tape therearound, the object including one electric wire or a bundle of electric wires;
a winding start section in which the tape is wound around a winding start portion of the object in a predetermined winding manner;
an oblique winding section adjacent to the winding start section, in which oblique winding of a plurality of tapes is provided around the object along a length direction of the object,
wherein the plurality of tapes has a same tape width or different tape widths to each other and is arranged at a predetermined angle with the length direction,
wherein when the plurality of tapes of the tape set has a same tape width, the plurality of tapes is wound around the object obliquely at a winding tape pitch which is greater than or equal to zero and smaller than or equal to three times as large as the tape width,
wherein when the plurality of tapes of the tape set has different tape widths, the plurality of tapes is wound around the object obliquely at a winding tape pitch which is greater than or equal to zero and smaller than or equal to three times as large as a maximum tape width of the plurality of tapes,
wherein the oblique winding is made with a winding length along the length direction,
wherein the winding length per turn of the oblique winding is defined by multiplying a sum of the winding tape pitch and an intersection width of one of the plurality of tapes with the length direction by a number of tapes of the tape set; and
a winding end section adjacent to the oblique winding section, in which a tape is wound around a winding end portion of the object in a same winding manner as the winding start section,
wherein tape winding is provided according to the tape winding method according to claim 1.
